(19) United States
(12) Patent Application Publication
(10) Pub. No.: US 2007/0089550 A1
(43) Pub. Date: Apr. 26, 2007

(54) Windowed pre-filter holder

(76) Inventor: James R. Norgaard, Medfield, MA (US)

Correspondence Address: Iandiorio & Teska, 260 Bear Hill Road, Waltham, MA, 02451-1018, US

(21) Appl. No.: 11/258,808

(22) Filed: Oct. 26, 2005

(51) Int. Cl. G01D 21/00

(52) U.S. Cl. 73/866.5

(57) ABSTRACT

A windowed pre-filter holder for a detector includes a proximate coupling for engaging with a detector and including a seal for sealingly the engaging one end of a pre-filter with a detector; a distal coupling for engaging the other end of the pre-filter; and a windowed protective housing extending between the couplings for viewing the pre-filter in situ.

### FIELD OF THE INVENTION

This invention relates to an improved, windowed pre-filter holder for a detector such as a total volatile organic detector.

### BACKGROUND OF THE INVENTION

Conventional total volatile organic detectors such as flame ionization and photo ionization detectors e.g. as the Photovac 2020 PRO produced by Photovac, Incorporated of Waltham, Mass. have been adapted to employ pre-filters to enable the detectors to detect concentrations of specific compounds as opposed to that of total volatile organic compounds. These pre-filters are made, for example, to absorb all organic compounds except the specific one to be monitored. Such pre-filters for photo ionization detectors are described in U.S. Pat. No. 5,654,498 and are available from Dragerwerk of Lubeck, Germany. These detectors adapted for compound specific detection can be used to detect concentrations of any one of the volatile organic compounds depending on the pre-filter used. The pre-filter typically includes an elongated glass tube which holds the chemical that will filter out or absorb all but the compound sought to be monitored. These glass tubes are housed in a probe including a sturdy metal tube to protect them from physical damage. One problem with this pre-filter adaptation is that when the pre-filter is saturated or “used up”, the readings will become distorted and unreliable. To prevent this the pre-filters must be changed frequently depending upon the environment in which they are used. For example, one manufacturer indicates on the detector display the number of times a pre-filter can be used in various environmental conditions. But these are estimates only and changing the pre-filter too early or too late can have detrimental consequences: too early and the cost of the replacement filters becomes an issue, too late and the readings may be unreliable. One manufacturer simply suggests one use and one use only before discarding and replacing which can significantly increase cost. Another problem associated with pre-filter use is that these detectors are often used to determine actions to meet environmental laws and regulations. For example, process air used in may different chemical processes must be cleaned before being released to the atmosphere. Cleaning is often achieved with a carbon filter. When the carbon filter is wearing out a gas of concern that begins to increase in the “clean air” may be benzene, a dangerous carcinogen. Therefore, as soon as benzene reaches an unlawful level, e.g., 1 ppm, the filter must be replaced to prevent contaminated air from being released and causing a health and/or environmental hazard to the community and exposing the processor to fines and imprisonment. Acting too late violates the law and causes a health hazard; acting too early means replacing expensive filters prematurely before they have fulfilled their useful life.

One way of more efficiently determining whether or not a pre-filter is still useable is to observe its color. The pre-filter changes color as it becomes used up. This is much more reliable. Unfortunately, the tube is not visible to the user inside the detector's protective tube. The user, typically a plant maintenance worker, generally will not remove the protective tube after each use to see if it has been used up. Rather he will use the detector until the readings become erratic, then change the pre-filter. At this point, the reliability of some number of previous readings is in doubt. Prudently that means that these tests may have to be redone, unnecessarily increasing the time, effort and cost involved.

### SUMMARY OF THE INVENTION

It is therefore an object of this invention to provide an improved windowed pre-filter holder for a detector.

It is a further object of this invention to provide such an improved windowed pre-filter holder for a detector which enables constant checking of the pre-filter condition in situ without removing or opening the holder.

It is a further object of this invention to provide such an improved windowed pre-filter holder for a detector which accommodates a wide variety of pre-filters.

It is a further object of this invention to provide such an improved windowed pre-filter holder for a detector which enables identification and replacement of pre-filters as soon as they are spent but not prematurely.

It is a further object of this invention to provide such an improved windowed pre-filter holder for a detector which enables increased reliability and accuracy of the associated detector.

It is a further object of this invention to provide such an improved windowed pre-filter holder for a detector which makes optimal, efficient use both technically and economically of the pre-filter.

The invention results from the realization that an improved pre-filter holder for a total volatile organic detector which enables constant observation of the pre-filter in situ can be achieved with a windowed pre-filter holder with a windowed protective housing extending between a proximate coupling for engaging a detector and sealingly engaging one end of a pre-filter and a distal coupling having an aperture or transparent portion for viewing the pre-filter in situ.

The subject invention, however, in other embodiments, need not achieve all these objectives and the claims hereof should not be limited to structures or methods capable of achieving these objectives.

This invention features a windowed pre-filter holder for detector. The holder includes a proximate coupling for engaging with the detector and including a seal for sealing and engaging one end of a pre-filter with a detector. There is a distal coupling for engaging the other end of that pre-filter. There is a windowed protective housing extending between the couplings for viewing the pre-filter, in situ.

In a preferred embodiment the windowed protective housing may include at least one aperture. It may include a plurality of apertures. Each aperture may include a transparent member. The housing or at least a part of it may be transparent.

### BRIEF DESCRIPTION OF THE DRAWINGS

Other objects, features and advantages will occur to those skilled in the art from the following description of a preferred embodiment and the accompanying drawings, in which:

FIG. 1 is a side elevational diagrammatic view of a volatile organic detector with a windowed pre-filter holder according to this invention;

FIG. 2 is an enlarged elevational diagrammatic view of the windowed pre-filter holder of FIG. 1;

FIG. 3 is a side sectional view of the windowed pre-filter holder of FIGS. 1 and 2;

FIG. 4 is a three dimensional view of the windowed pre-filter holder of FIGS. 2 and 3; and

FIGS. 5 and 6 are views similar to FIG. 2 illustrating alternative windowing of the holder.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

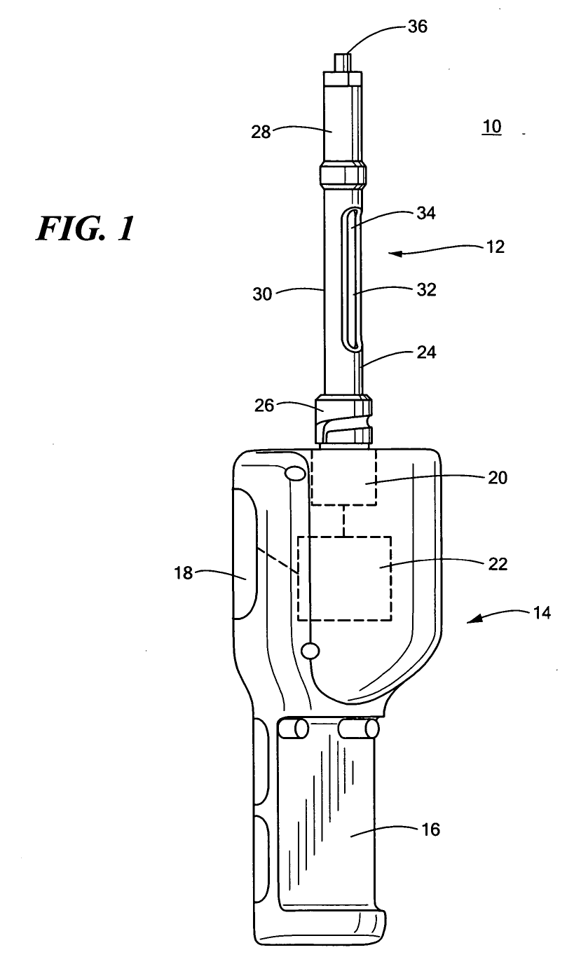

There is shown in FIG. 1 a total volatile organic detector 10 including a windowed pre-filter holder 12 according to this invention installed on a conventional photo ionization detector 14 having a handle 16 for containing the batteries, for example, a display 18 and a photo ionization detection chamber 20. Detector 14 also includes electronic processing and logic circuits 22 which process the output of photo ionization detector 20 and provide the results on display 18. Windowed pre-filter holder 12 includes a housing 24 attached to detector 14 by proximate coupling 26 and having at its other end a distal coupling 28. Between coupling 26 and 28 is windowed housing 30 which includes at least one window or aperture 32 through which can be viewed in situ at all times the pre-filter 34 which is disposed in housing 30 safe from physical harm or abuse. Thus any visible change in pre-filter 34, such as, color can be immediately seen and the pre-filter can be discarded and replaced at the optimum time.

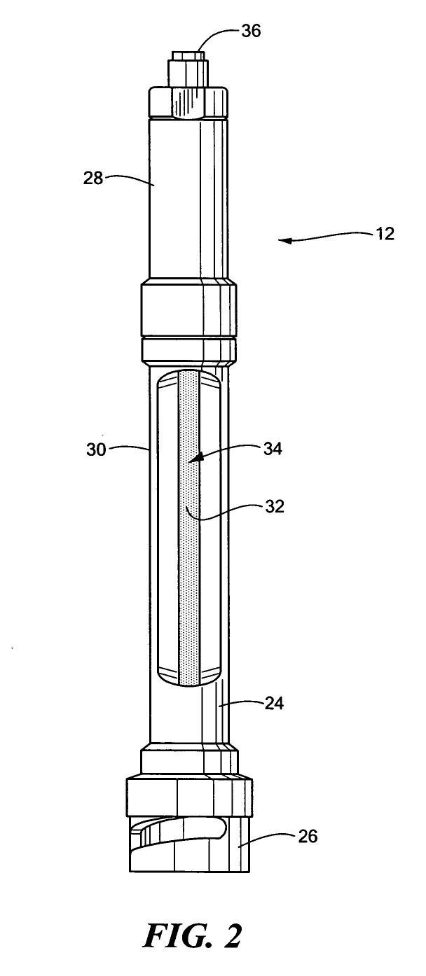

In operation, air is drawn in through inlet nozzle 36 and through coupling 38 into pre-filter 34. Assuming pre-filter 34 is for a specific compound such as benzene all of the compounds are absorbed or filtered out by pre-filter 34 while benzene will continue through coupling 26 into photo ionization chamber 20. There the selected volatile organic compound is sensed and the output of the photo ionic detector is delivered to signal processing circuits 22, which determine the concentration of the compound and deliver the appropriate information to display 18. The construction of windowed pre-filter holder 12 is shown enlarged for easier understanding in FIG. 2.

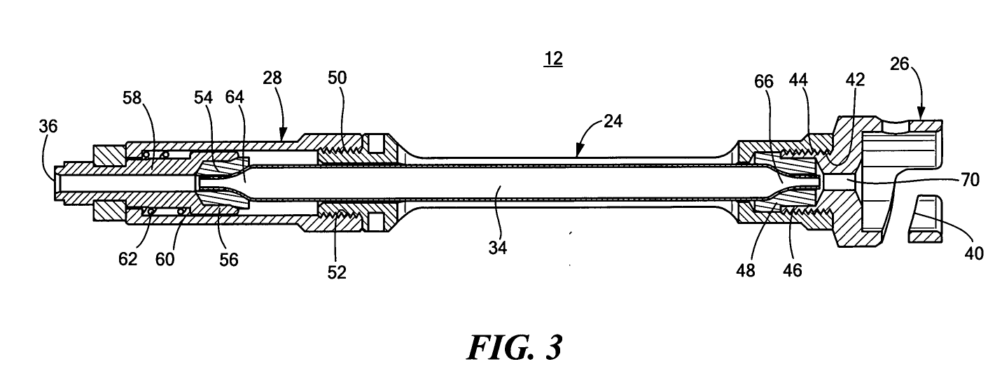

In one specific embodiment, windowed pre-filter holder 12, FIG. 3, includes a proximate coupling 26 with a bayonet connection 40. Coupling 26 includes a male external threaded nipple 42 which engages with the internally threaded portion 44 of housing 24. Seated in well 46 of nipple 42 is a seat or seal 48 made of a flexible material for gripping one open end of pre-filter 34. As explained in the background, pre-filter 34 may be an elongated glass tube, such as available from Draigerwerk of Lubeck, Germany and it typically contains filtering material that removes all volatile organic compounds except the one sought to be detected. Distal coupling 28 includes internal threads 50 which mate with external threads 52 at the distal end of housing 24. The other end of pre-filter 34 is engaged with a flexible seat 54 set into well 56 of distal seal adapter 58 which contains inlet nozzle 36 and has a shoulder 60 for receiving compression spring 62. Distal coupling 28 can be removed by unthreading to insert pre-filter 34 into holder housing 24 and coupling 26. Then distal coupling 28 is reinstalled by once again engaging threads 50 and 52 so that a force is exerted by spring 62 through seat 54 onto the distal end 64 of pre-filter 34. The proximate end 66 is thus pressed against and sealed by seat 48.

Pre-filter 34 comes with its glass tube tips intact but the tips are broken off before it is inserted into holder 12 in order to provide a clear ingress at 64 and egress at 66 of the atmosphere to be sampled. Seat 48 truly acts as a seal so that only way air can reach the photo ionization chamber in the detector is through the channel 70 in coupling 26. In contrast seat 54, while it may be made of the same material, does not necessarily have to seal the distal end 64 of pre-filter 34. It does, however, form the function of cushioning and standardizing the reception of pre-filter 34 in holder 12. Sealing is not necessary at the distal end 64 because no matter where the air comes from, nozzle 36 or elsewhere, it will be forced to go through pre-filter 34 before it can pass through channel 70 in coupling 26 to the photoionization chamber in the detector. While the pre-filter shown here, and therefore necessarily the holder 12 in housing 24, have a high aspect ratio of length to width, this is not a necessary limitation of the invention. This is simply the most conventional type of pre-filter available. The invention would work with aspect ratios of more equal or even inverse aspect ratios.

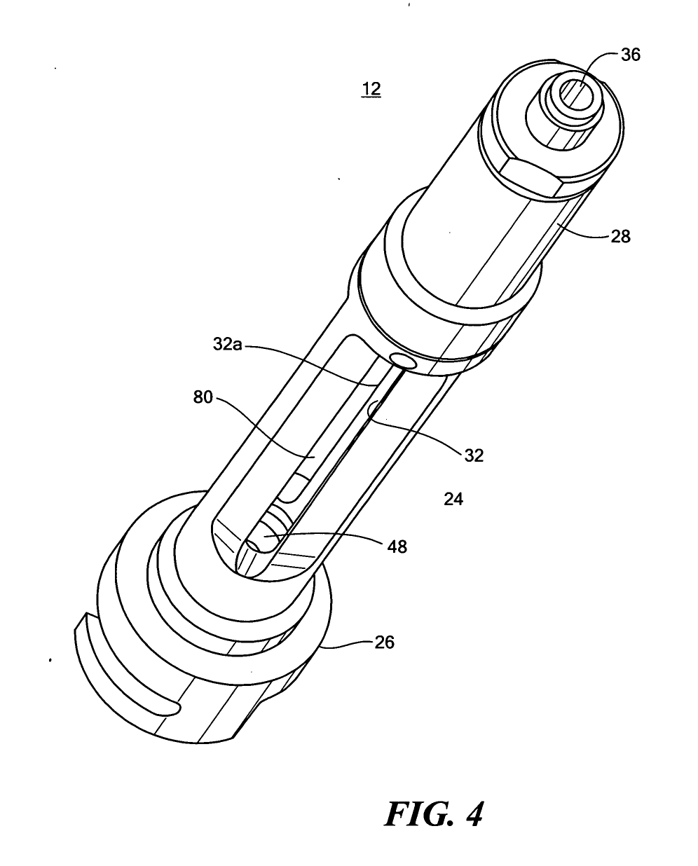

While thus far only one aperture in shown in windowed housing 24, this is not a necessary limitation of the invention. There is no pre-filter in housing 12 and thus two apertures 32 and 32a can be seen as well as the lower flexible seat or seal 48. In addition, one or both of the apertures 32 and 32a may not be just an aperture but may have a transparent member 80 in it. There may be two or more apertures, for example in FIG. 4 there are two apertures, 32 and 32a on opposing sides (not necessarily opposing).

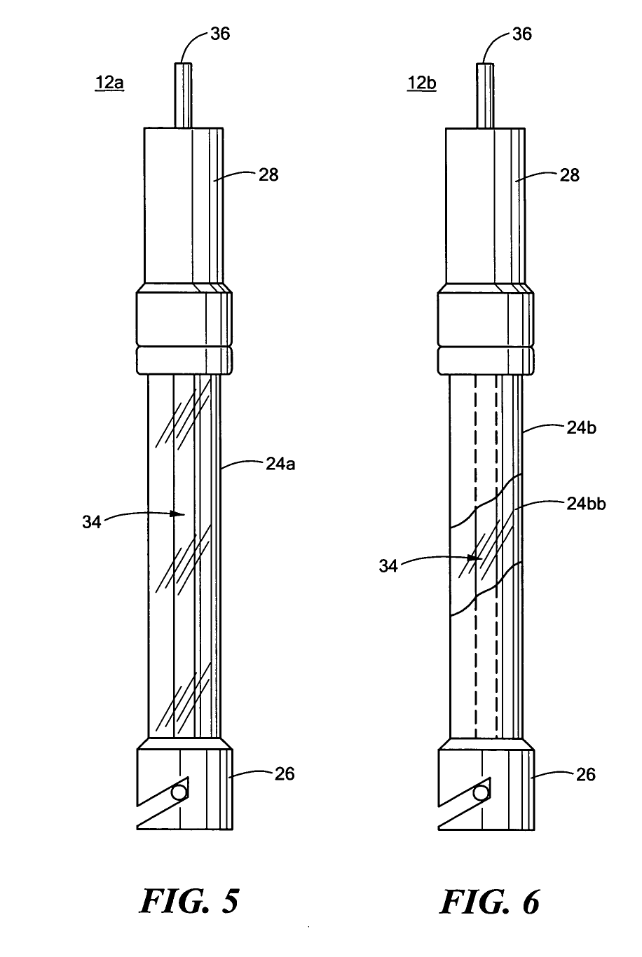

Although thus far the windowed holder 12 is shown with one or more apertures with or without transparent panels, this is not a necessary limitation of the invention. For example, the entire housing 24a may be made of transparent material, FIG. 5, or a housing 24b, FIG. 6, may have at least a portion, 24bb, of it be transparent. The windowed portion may have any shape, regular or irregular, and extend in any direction, so long as it permits in situ viewing of the pre-filter inside the holder. The use of a multiple apertures or a very large aperture is advantageous in that it increases the illumination of the pre-filter within and also insures that at least a portion of the pre-filter is visible at all times to the user of the detector. While in this particular embodiment the couplings are independent of the housing one or both of them may as well be integral with the housing and the proximate coupling may be integral with the detector. And various mechanical arrangements can be used to properly insert, seat, and remove the pre-filter without departing from the windowed notion of this invention. By windowed is meant any opening for the emission of light and or air. It may include merely an opening such as a bank teller's window or it may involve the use of a transparent panel.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A windowed pre-filter holder for a detector, the holder comprising;
a proximate coupling for engaging with a detector and including a seal for sealingly engaging one end of a pre-filter with a detector;
a distal coupling for engaging the other end of the pre-filter; and
a windowed protective housing extending between said couplings for viewing the pre-filter in situ.

2. The windowed pre-filter holder of claim 1 in which said windowed protective housing includes at least one aperture.

3. The windowed pre-filter holder of claim 1 in which said windowed protective housing includes a plurality of apertures.

4. The windowed pre-filter holder of claim 1 in which the aperture includes a transparent member.

5. The windowed pre-filter holder of claim 3 in which the apertures include transparent members.

6. The windowed pre-filter holder of claim 1 in which the housing is transparent.

7. The windowed pre-filter holder of claim 1 in which at least part of the housing is transparent.
